(19) United States
(12) Patent Application Publication
(10) Pub. No.: US 2024/0354382 A1
(43) Pub. Date: Oct. 24, 2024

(54) SYSTEMS AND METHODS FOR AI ENABLED DELIVERY OF USER SPECIFIC SERVICES

(71) Applicant: Datum Point Labs Inc., Jackson, WY (US)

(72) Inventors: PATRICK NUNALLY, San Diego, CA (US); MICHAEL T. LUCAS, Del Mar, CA (US); TYLER J. LUCK, Rancho Sante Fe, CA (US)

(21) Appl. No.: 18/436,497

(22) Filed: Feb. 8, 2024

Related U.S. Application Data
(60) Provisional application No. 63/461,026, filed on Apr. 21, 2023.

(51) Int. Cl. G06F 21/31; G06F 21/62

(52) U.S. Cl. CPC G06F 21/31; G06F 21/6254

(57) ABSTRACT

Embodiments described herein provide systems and methods for an AI native operating system wrapper. Methods may include receiving, by a computing device via a user interface, a user input associated with an application; receiving, by the computing device via a data interface, stored information associated with the user; determining, via an artificial intelligence (AI) model based on the user input and the stored information, one or more actions, performing the one or more actions on the application; and transmitting output from the application to the user interface.

### CROSS REFERENCE(S)

The instant application is a nonprovisional of and claim priority under 35 U.S.C. 119 to U.S. provisional application No. 63/461,026, filed Apr. 21, 2023, which is hereby expressly incorporated by reference herein in its entirety.

### TECHNICAL FIELD

The embodiments relate generally to systems and methods for AI enabled delivery of user specific services.

### BACKGROUND

Modern society has ingrained computing deeply into its core. It has become a ubiquitous resource, much like water, food, energy, housing, and other people. Its interactions with other types of resources are incredibly diverse, and it has become one of the two primary gateways for human functionality. The other is direct physical interaction with tools, people, or similar entities.

The current focus in the art has been on expanding the deployment of computer setups which function as gateways. Collectively, these computing arrangements provide access to and can participate in an enormous range of processing, storage, information, experiential, and communication resource utilization. The rationale behind using these computer arrangements is to present tools as a means to serve user commands. Essentially, users use computing arrangements to satisfy needs or desires. Achieving these objectives necessitates utilizing resources, and modern computing arrangements offer resource opportunities that encompass a significant portion of humanity's knowledge and expertise, as well as an almost limitless variety of commercial, communication, entertainment, and interpersonal resources, along with countless possibilities for combining these resources.

Existing computing resources, facilitated by both intranets and the Internet cloud, offer a vast distributed array of potential resources to be commanded. This vast array, owing to its size, diversity, and global reach, presents formidable challenges to fully or even moderately exploit, and no computing technology provides a practical means for individuals or groups to apply the full scope of resource possibilities outside of their knowledge and ability to make requests. Users are also faced with privacy concerns as they interact with various services. Therefore, there is a need for improved systems and methods for AI enabled delivery of user specific services.

### BRIEF DESCRIPTION OF THE DRAWINGS

FIG. 1 illustrates a framework for an AI native operating system wrapper, according to some embodiments.

FIG. 2 illustrates a framework for an application of an AI native operating system wrapper, according to some embodiments.

FIG. 3 is a simplified diagram illustrating a computing device implementing the framework described herein, according to some embodiments.

FIG. 4 is a simplified block diagram of a networked system suitable for implementing the framework described herein.

FIG. 5 is a simplified block diagram of a vehicle computing system with an AI native operating system wrapper, according to some embodiments.

FIG. 6 is an example logic flow diagram, according to some embodiments.

### DETAILED DESCRIPTION

Existing computing resources, facilitated by both intranets and the Internet cloud, offer a vast distributed array of potential resources to be commanded. This vast array, owing to its size, diversity, and global reach, presents formidable challenges to fully or even moderately exploit, and no computing technology provides a practical means for individuals or groups to apply the full scope of resource possibilities outside of their knowledge and ability to make requests. Users are also faced with privacy concerns as they interact with various services.

Embodiments of the present disclosure provide an artificial intelligence native operating system wrapper (AINOSW) configured to reduce the collection of user data in the background from many to one, while still serving the needs of the applications and the user, and also providing various other benefits. In some embodiments, the AINOSW acts as an abstraction layer that provides customized services, security, and data privacy. The AINOSW may learn user information, including sensitive information, through user interactions with applications via the AINOSW. This user information may be utilized by the AINOSW to learn user information that may be used in other instances, and also to learn user preferences to customize the user experience. For example, the AINOSW may learn through user interaction details about the user such as their name, phone number, and email address. The AINOSW may also learn user information via sensors (e.g., GPS location). The AINOSW may also learn that the user prefers their phone number to not be shared with a certain class of applications/providers. When the user is accessing a specific server via the AINOSW, the AINOSW may abstract from the user the input of their information, and the AINOSW may input only the information that is desired by the user according to the learned preferences. In some embodiments, proxy information may be used in order to anonymize user information as preferred. The learned user information and preferences may also be used to automate certain tasks and/or inform how certain tasks are performed.

In some embodiments, systems described herein may assist users in achieving their goals both within a computing environment as well as in their physical environment. The AI native operating system wrapper can be used to gather local and remote sensor data as well as user related data to identify, evaluate, select, and/or use resources that match users' immediate and long term needs in relation to their situational needs. Resources used via the AINOSW may be part of a distributed hierarchy of modules which can be employed by a common user interface and relevant sensor representation of user activities. Using a local AI native man-machine interface suitable for spatiotemporal data gathering, resulting in outcomes optimized for the user's current and future objectives. The system for creating an AI native operating system wrapper may include a hardware and software computing arrangement that provides standardized resources and/or specifications for the operating system. The AINOSW may support provisioning of purpose expression arrangements for expressing user-specified purposes and standardized resource identification management arrangements to identify resources with specific attributes. Stakeholder identification information sets, purpose class arrangements, and mechanisms for selecting resources for user computing purposes may also be included.

In some embodiments, an AI native operating system wrapper may be utilized for connected computing. The operating system wrapper may identify, evaluate, select, and/or use resources that match user-specified purposes, where the resources are part of a distributed resource environment. The AI native operating system wrapper includes one or more standardized subsystems, including a subsystem for enabling avatar-based expression arrangements for expressing user-relative purposes and a subsystem for enabling standardized resource identification management arrangements. The subsystems include stakeholder identification information sets, purpose class arrangements, and mechanisms for selecting resources for user computing purposes.

In some embodiments, the user interface will be a mobile device such as a mobile smartphone, tablet or in some cases a fixed computational device such as an automobile. The systems and methods described herein also include a backend triage of services including but not limited to AI systems to provide uniform user interface and perceived continuity of service, providing services as needed with the goal of anticipating user needs based on historical patterns of operations, locality and sensors selected from the list including accelerometers, photometric, LIDAR, UWB, sonic. charge-coupled, imaging, smart grid. gyroscopic, infrared, temperature, proximity, chromatographic, gas, humidity, barometric, level, light, pressure, chemical, biomedical, and other sensors.

In some embodiments, the system additionally routes questions or active interaction (as indicated) to select data collection permissions from a user's mobile device, regardless of manufacturer or platform. This approach eliminates the need for costly middleware applications.

In one embodiment, a user may use natural language processing as well as user input and local or distributed sensor data to interact with a sentiment driven avatar acting as the common man-machine interface to the AI native operating system wrapper, which retrieves personalized data from any combination of the user's historical activities, current condition derived from one or more sensors, local mobile data, remote server data, IoT data, or vehicle data.

In some embodiments, an AI native operating system is designed for connected computing. This operating system may include, at least in part, a hardware processor, memory, communications, and man-machine interface provisions. The AI native operating system may be configured to identify, evaluate, select, and/or utilize resources that match user-specified purposes based on their respective attributes. These resources form a distributed resource hierarchy, and their suitable identification, evaluation, selection, and/or use leads to outcomes optimized for users' respective purposes.

The operating system may include a computing arrangement of hardware and software that includes additional subsystems for an operating system. These subsystems include a subsystem to enable standardized stakeholder identification information sets for stakeholders of computing arrangement resources. These sets include biometrically based identification information instances acquired through biometric sensor arrangements. Another subsystem enables standardized purpose class arrangements for organizing computing environment resources. These purpose class arrangements are organized as specified purpose class objective sets with respective user purpose fulfillment specifications. The objective sets contain computing resources as members that share objective user purpose fulfillment specification information. Additionally, a subsystem enables mechanisms for identifying and selecting resources for user computing arrangement purpose fulfillment. The identified and selected resources are associated with respective expressions of user purpose specifications and quantized quality-to-purpose instances.

Some embodiments additionally may include a purpose expression arrangement that enables users to express their standardized and interoperable interpretable purpose expression specifications, which are expressed and interpreted using natural language processing, standardized lexicons and one or more processing algorithms selected from list including: AdaBoost, Association, Clustering, Context Engineering, Generative, K-Nearest Neighbor, Logistic Regression, Naive Bayes, Neural Network, Random Forest and Support Vector Machine.

A resource identification management arrangement may enable standardized resource identification information sets. These sets include unique respective resource identifiers and resource attributes associated with those identifiers. At least a portion of the resource attributes may be tamper-resistant and securely quantized.

In some embodiments, the man-machine interface comprises an avatar which in interaction with the user forms a normalization of user interaction allowing the AI native operating system wrapper to collect, analyze, understand, and predict user preferences over time. Additionally, the AI native operating system wrapper may operate in real time to interact with users, provide for user needs and preferences as well as protect user data through a dynamic security protocol.

Embodiments described herein provide a number of benefits. For example, data security and privacy may be improved via the methods described herein, as the personalized data sharing allowed by the AI operating system may provide only certain information and/or proxy information to resources requesting data. This may be achieved through learned rules/parameters rather than complicated configuration of custom rules. The memory and/or computation resources required to provide the complex data sharing and automation may be reduced through providing a central AI operating system that learns flexible rules that may be applied across multiple different applications.

The native AI operating system wrapper disclosed herein automates tasks for the user, optimizes resource allocation, and streamline workflows, thereby increasing efficiency. The native AI operating system disclosed herein learns from user behavior and preferences to provide personalized experiences and recommendations, improving the overall user experience. The native AI operating system disclosed herein uses AI-based security measures to detect and prevent cyber threats and ensure user identification making it more secure than traditional operating systems. The native AI operating system wrapper adapts to changing user needs, providing organizations with the flexibility they need to serve users that would otherwise be unreachable.

Systems and methods described herein provide enhanced power optimization which results from the combined use of consolidated service resources where multiple location requests issued from an array of application operations can be redirected to a previous read of location where either time or other sensor analysis indicates that no material difference in location has occurred thus negating additional location reads. Providing a single repository of data tagged by the AI native operating system wrapper such that repetition of common data is negated may enhance security by nonproliferation of personal data and may reduce local and remote storage requirements.

By providing a common AI driven user interface which allows for the presentment and operations of associated (loaded or previously trained) applications, users never have to navigate diverse and complex user interfaces or search for functionality or data buried in menus. The dynamic security afforded by the AI native OS wrapper enables single point of security risk assessment resulting in a “one and done” solution. Dynamic security allows developers to certify once and leverage consumer data which has already been released by users and collected with their consent to those functions or services authorized for use/permission. This may reduce the instances in which the system may be otherwise required to prompt for user input, thereby increasing computational efficiency.

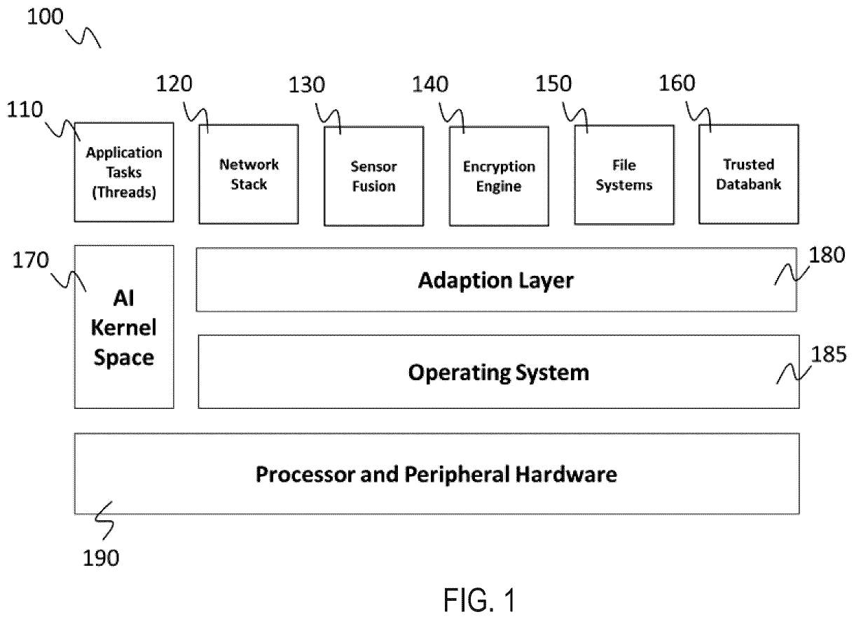

FIG. 1 illustrates an exemplary framework 100 for an AI native operating system wrapper (AINOSW), according to some embodiments. AINOSW 100 may be built on a pre-existing operating system 185. In some embodiments, an AI kernel 170 may be included to provide kernel-level AI access to processor and peripheral hardware 190. The AI Kernel 170 may be loaded into an associated separate area of memory, which is protected from access by application software. The AI kernel may be configured to perform tasks by commanding an adaptation layer 180 for the running of processes, managing hardware devices and peripheral hardware 190.

Components contributing to the operation of AI kernel 180 may include resource support modules including a trusted databank 160 which provides for secure anonymity data storage. A file system 150 data structure may be provided, which controls how data is stored and retrieved. An encryption engine 140 may be used to isolate and accelerate encryption and hashing of data that is stored and retrieved. One or more sensor fusion 130 may be provided, which may be implemented as an algorithm correlated to a sensor grouping selected from a list comprising AdaBoost, Association, Clustering, Context Engineering, Generative, K-Nearest Neighbor, Logistic Regression, Naive Bayes, Neural Network, Random Forest and Support Vector Machine. Also provided may be a network stack 120 which defines the communication protocols used by the system and the implementation of them as well as application tasks 110 which are processes or training which provide specific functionality.

Adaption layer 180 may provide unified flexible access to higher layer components (e.g., components 110-160). In some embodiments, rather than higher layer components directly accessing resources of operation system 185 and/or processor and peripheral hardware, AI kernel 170 controls adaption layer 180 such that components such as application tasks 110 receive services from operating system 185 in a modified manner.

In one example, an application task 110 may request a GPS location from operating system 185. AI kernel 170 may have learned based on previous user interactions that the user prefers to anonymize GPS location for certain types of applications (e.g., social media applications). Based on this learned preference, AI kernel space may command adaption layer 180 to anonymize any GPS data that is delivered by operating system 185.

In another example, a newly downloaded application task 110 may request user information (e.g., name, email address, etc.). Based on learned preferences, AI kernel 170 may control adaption layer 180 to provide the requested user data. If the application is trusted based on some learned preference, the full user information may be provided, in some cases without requiring any additional input from the user. In some cases, the application may not be trusted or the AI kernel has otherwise learned user preference to anonymize personal data. In this case, proxy user information may be provided (e.g., an email address that is manages by the system and not the user's personal email address).

Adaption layer 180 as controlled by AI kernel 170 may modify the use of operating system 185 in a number of ways, controlling network access (e.g., via network stack 120), use of sensor data (e.g., via sensor fusion 130), encryption of data (e.g., via encryption engine 140), file system management (e.g., via file systems 150), storage of information (e.g., via trusted databank 160) etc. In some embodiments, multiple features may be modified together. For example, AI kernel 170 may, based on a network configuration and a learned user preference, encrypt sensor information that is transmitted over a network. This modification over default operating system 185 behavior may include adaption of application tasks 110, network stack 120, sensor fusion 130, encryption engine 140, etc. These modifications allow for dynamic operation without requiring complex configuration by a user.

Adaption layer 180 may also be utilized in the automation of tasks. For example, AI kernel 170 may learn a user preference that may be used to partially or fully automate a task. For example, AINOSW 100 may present a user interface to a user that allows access to the various functions of AINOSW 100 through a uniform interface (e.g., a chat interface). AI kernel 170 may learn that when a user requests via the user interface information regarding weather, that the user prefers to receive weather information for a certain location, not necessarily the user's current location. Accordingly, the user interface may provide weather information for the preferred location, which may include retrieving the preferred location form memory and requesting weather information for that location via network stack 120. Further, it may be a learned user preference to hear the hourly weather forecast for the next three hours. Based on this information, the retrieved weather information may be modified accordingly before being provided to the user via the user interface.

AINOSW may learn user preferences and information in a number of ways. For example, sensor information may provide direct information to AINOSW. In another example, the first time a user performs some action (e.g., requesting weather information), AINOSW may prompt a user with questions such as “For which location would you like weather information” or “over what time period would you like weather information”. After receiving responses to these prompts one or more times, AINOSW 100 may learn the preferences of a user. Preferences may be situational, and AINOSW 100 may learn user preferences based on a number of criteria (e.g., which device the user is using, the user's location, timey of day, sensor information, etc.). User information (e.g., name, address, email address, phone number, website credentials etc.), may likewise be learned by AINOSW 100. For example, when a user is accessing an application that requires certain user information which AINOSW 100 has not yet learned, AINOSW 100 may prompt the user for the information directly, or intercept the information that is entered manually by a user into the application's interface. In some embodiments, user information and preferences may be updated by one or more processes. For example, AINOSW 100 may provide a weather report based on learned user preferences, and if the user wants different information than what was provided, the user may request different information. This request for different information may be used to update user preferences for AINOSW.

Using learned user information and preferences etc., AINOSW 100 may predict desired application behavior based on the user information, preferences, and other data. AINOSW 100 may learn based on user behavior, that certain application behavior is desired in connection with specific sensor data. For example, a user may retrieve information from a specific application commonly when at a certain location which may be determined by a GPS sensor. The AI based (e.g., neural-network based) model may be provided user information and sensor data as inputs, and predict desired application behavior based on those inputs. The AI based model of AINOSW 100 may then automate application tasks based on this prediction. In some embodiments, the AI based model may be a deep learning based model. In some embodiments, the AI based model may include machine learning components and/or heuristics used in making predictions.

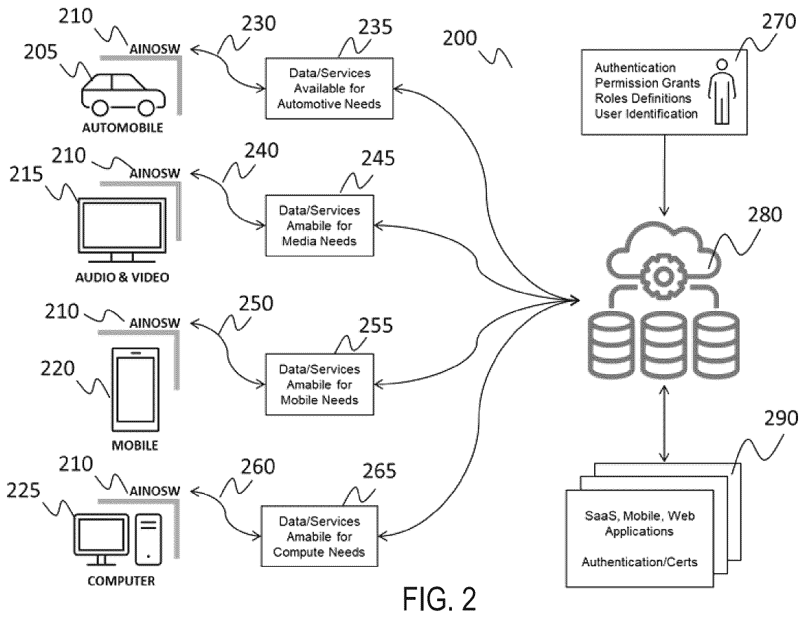

FIG. 2 illustrates a framework 200 for an application of an AI native operating system wrapper, according to some embodiments. Framework 200 illustrates multiple examples of components that may utilize the framework 100, and the components illustrated may be used in many different combinations other than what is illustrated. Framework 200 may use an AINOSW 210 implemented consistent with the disclosure of AINOSW 100 of FIG. 1. In the illustrated embodiment, various edge devices, including automobiles 205, media appliances 215, mobile devices 220 and computational devices 225 each having its own AINOSW 210. Each AINOSW 210 provides a unique communication channel 230, 240, 250 & 260 respectively. Rather than individual platforms gathering and retaining their own data all personal information or user specific data is retrieved from and pushed to the central secure platform 280. In this way, a user may interact using multiple devices equipped with an AINOSW in communication with the central secure platform, providing consistency of user experience across multiple devices. Further, user preferences learned in one device may be applied consistently across other devices automatically.

In some embodiments, each edge device of a type (e.g., automotive, media, mobile and computational) may be tailored to manage local data gathering, processing, compression, securing, fetching and use of data as needed by automotive 235, media 245, mobile 255 and computational 265 classes of data requests respectively. Account owners or users may maintain policy, including authentication, permission grants, roles definitions and personal identification data 270 at the central secure platform 280 which prevents duplicative distribution of account data as well as adaptive authentication and certifications of service providers 290. In this way, data at the secure platform is stored and accessible without duplication at disparaged service providers. For example, user credentials for accessing bank information may be stored securely at central secure platform 280. A user attempting to access bank information via different devices (e.g., computer 225 and mobile device 220) may not be required to provide the credentials, nor would those credentials need to be duplicated across those devices. Rather, the credentials may be accessed (e.g., as allowed by AINOSW 210) at central secure platform 280 as needed. This may increase security, allow for consistent user experience, and reduce memory requirements at edge devices. To a user, the interface to bank information may be presented in a uniform way across devices, with the AINOSW 210 acting as an intermediary between the user and the banking application, such that a user is not directly interacting with the banking application, rather the AINOSW presents to the user an interface that is based on the users preferences, and interacts with the bank application according to learned user preferences.

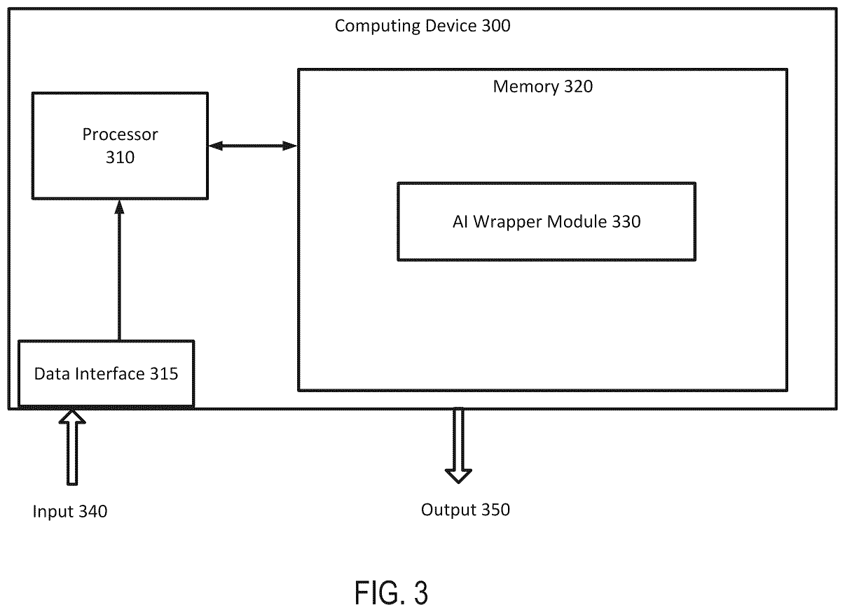

FIG. 3 is a simplified diagram illustrating a computing device 300 implementing the framework described herein, according to some embodiments. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for AI wrapper module 330 that may be used to implement and/or emulate the systems and models, and/or to implement any of the methods described further herein.

AI wrapper module 330 may receive input 340 such as user input, sensor data, etc. and generate an output 350 such as information for display to a user via a user interface device. For example, AI wrapper module 330 may be configured to act as an abstraction layer interface to computing device 300, allowing for abstraction and/or automation of tasks as described herein.

The data interface 315 may comprise a communication interface, a user interface (such as a voice input interface, a graphical user interface, and/or the like). For example, the computing device 300 may receive the input 340 from a networked device via a communication interface. Or the computing device 300 may receive the input 340, such as user prompts, from a user via the user interface.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

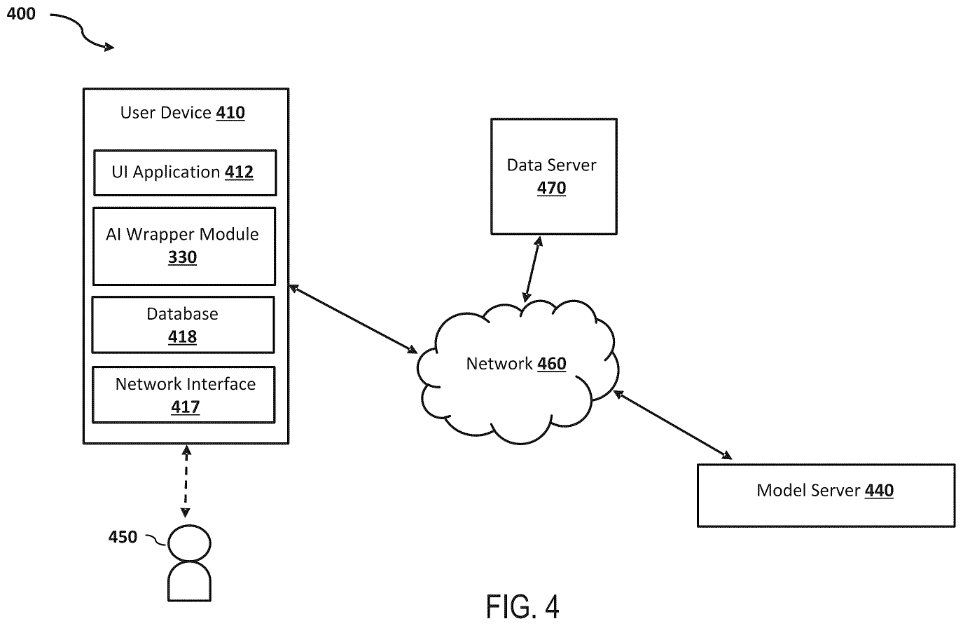

FIG. 4 is a simplified block diagram of a networked system 400 suitable for implementing the framework described herein. In one embodiment, system 400 includes the user device 410 (e.g., computing device 300) which may be operated by user 450, data server 470, model server 440, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 410 is used in training neural network based models. In some embodiments, user device 410 is used in performing inference tasks using pre-trained neural network based models (locally or on a model server such as model server 440).

User device 410, data server 470, and model server 440 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460. User device 410, data server 470, and/or model server 440 may be a computing device 300 (or similar) as described herein.

In some embodiments, all or a subset of the actions described herein may be performed solely by user device 410. In some embodiments, all or a subset of the actions described herein may be performed in a distributed fashion by various network devices, for example as described herein.

User device 410 may be implemented as a communication device that may utilize appropriate hardware and software configured for wired and/or wireless communication with data server 470 and/or the model server 440. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 410 of FIG. 4 contains a user interface (UI) application 412, and AI wrapper module 330, which may correspond to executable processes, procedures, and/or applications with associated hardware. For example, the user device 410 may allow a user to access services across devices with consistent experience preserved by the AI wrapper module 330 by learning preferences across devices. In other embodiments, user device 410 may include additional or different modules having specialized hardware and/or software as required.

In various embodiments, user device 410 includes other applications as may be desired in particular embodiments to provide features to user device 410. For example, other applications may include security applications for implementing client-side security features, programmatic client applications for interfacing with appropriate application programming interfaces (APIs) over network 460, or other types of applications. Other applications may also include communication applications, such as email, texting, voice, social networking, and IM applications that allow a user to send and receive emails, calls, texts, and other notifications through network 460.

Network 460 may be a network which is internal to an organization, such that information may be contained within secure boundaries. In some embodiments, network 460 may be a wide area network such as the internet. In some embodiments, network 460 may be comprised of direct physical connections between the devices. In some embodiments, network 460 may represent communication between different portions of a single device (e.g., a communication bus on a motherboard of a computation device).

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

User device 410 may further include database 418 stored in a transitory and/or non-transitory memory of user device 410, which may store various applications and data (e.g., model parameters) and be utilized during execution of various modules of user device 410. Database 418 may store user information, etc. In some embodiments, database 418 may be local to user device 410. However, in other embodiments, database 418 may be external to user device 410 and accessible by user device 410, including cloud storage systems and/or databases that are accessible over network 460 (e.g., on data server 470).

User device 410 may include at least one network interface component 417 adapted to communicate with data server 470 and/or model server 440. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 470 may perform some of the functions described herein. For example, data server 470 may store user preferences, user information, security credentials, etc. Data server 470 may be a central secure platform 280. Data server 470 may provide data to user device 410 and/or model server 440. For example, training data may be stored on data server 470 and that training data may be retrieved by model server 440 while training a model stored on model server 440.

Model server 440 may be a server that hosts models described herein. Model server 440 may provide an interface via network 460 such that user device 410 may perform functions relating to the models as described herein (e.g., an AI model that predicts desired system behavior based on user information and preferences). Model server 440 may communicate outputs of the models to user device 410 via network 460. User device 410 may display model outputs, or information based on model outputs, via a user interface to user 450.

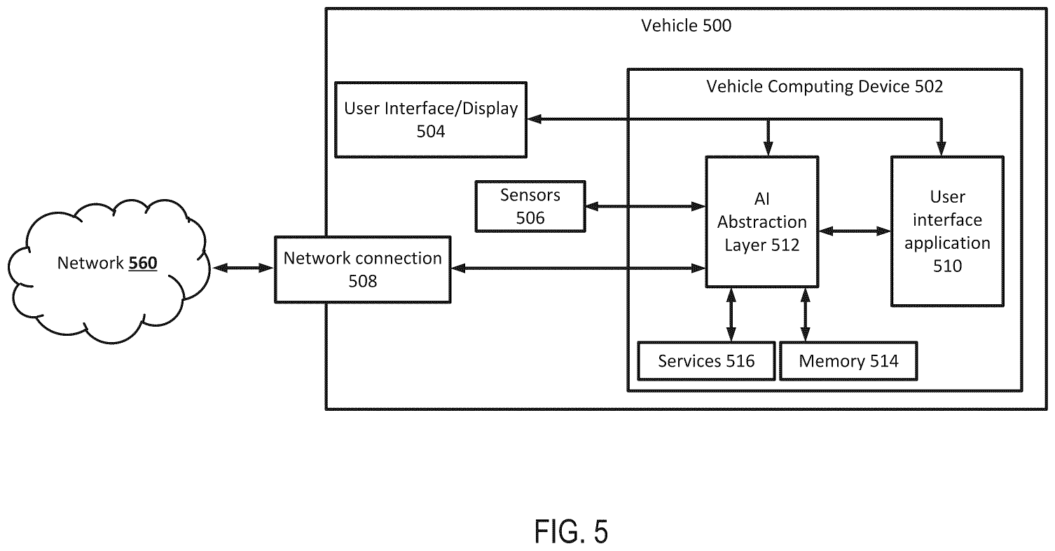

FIG. 5 is a simplified block diagram of a vehicle computing system with an AI native operating system wrapper, according to some embodiments. The description herein is with respect to a vehicle 500, but it should be understood that the description may apply, in some embodiments, to various other types of devices. Vehicle 500 may include a vehicle computing device 502 (e.g., a computing device 300 or user device 410). Computing device 502 includes a user interface application responsible for direct interaction with a user via user interface/display 504. User interface/display 504 may be, for example, a touch screen interface, an audio interface, or other user input/output device. As described herein, an AI abstraction layer 512 may be provided by an AI native operating system wrapper (e.g., as illustrated in FIG. 1). The AI abstraction layer may have direct access to a memory 514, sensors 506, network 560 via network connection 508, services 516 and/or sensors 506. Network 560 may be a network 460 with access to a central secure platform 280. Sensors 506 may include inertial sensors, GPS, cameras, microphones, etc. AI abstraction layer 512 may also, in some embodiments, have direct control and/or access to user interface/display 504.

AI abstraction layer 512 may provide an abstraction for user interface application 510 to the other illustrated components. For example, one service 516 may be GPS navigation. The user may interact with the GPS navigation service via the uniform user interface provided by user interface application 510 and AI abstraction layer 512. Based on learned user information and preferences, the behavior of the GPS navigation service 516 may be modified or automated in some manner by AI abstraction layer 512. The user information and preference may be retrieved from a central secure platform 280 via network connection 508. In another example, AI abstraction layer may handle providing security credentials for a service 516 without prompting the user each time. AI abstraction layer 512 may determine that a security credential may be provided to a certain service 516 based on a learned preference. In some embodiments, AI abstraction layer may prompt a user for confirmation that they would like to access the secure service 516 via user interface/display 504. If the user responds affirmatively, AI abstraction layer 512 may provide the credentials stored in memory 514 or central secure platform 280 without further prompting the user for the credentials. Sensor data, user data, and learned user preferences, etc. may be shared by AI abstraction layer 512 with other devices via network 560, for example as described in FIG. 3. By sharing user information, duplication of information across devices may be avoided, and user experience may remain consistent across devices.

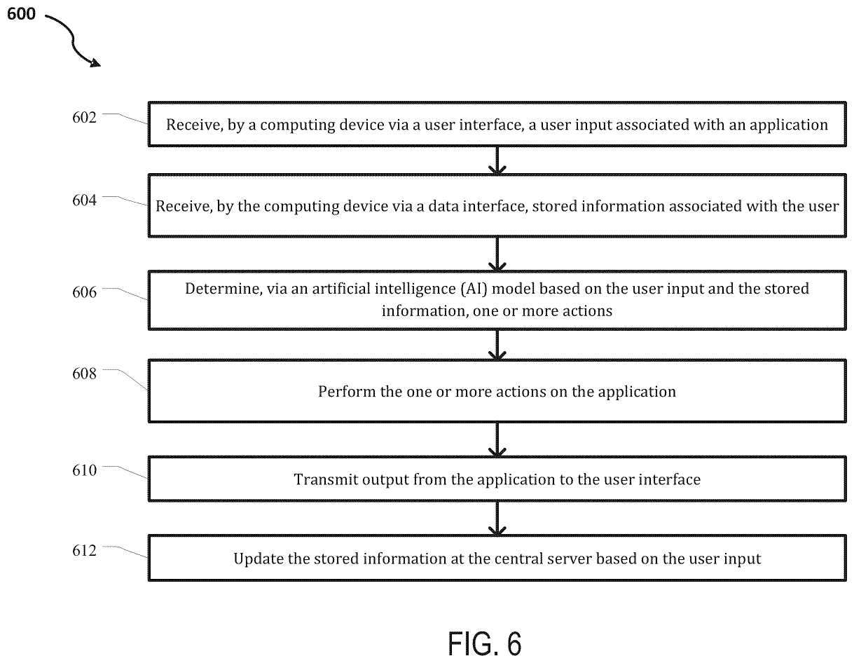

FIG. 6 is an example logic flow diagram, according to some embodiments described herein. One or more of the processes of method 600 may be implemented, at least in part, in the form of executable code stored on non-transitory, tangible, machine-readable media that when run by one or more processors may cause the one or more processors to perform one or more of the processes (e.g., computing device 300). In some embodiments, method 600 corresponds to the operation of the AI wrapper module 330 that performs abstraction functions as described herein.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a computing device (e.g., computing device 300, user device 410, or vehicle computing device 502) receives via a user interface, a user input associated with an application. For example, the user may input a request for information, a prompt for an automated task, etc.

At step 604, the computing device receives, via a data interface (e.g., data interface 315 or 417), stored information associated with the user. Stored information may include, for example, identifying information, security credentials, learned user preferences, historical activities data, sensor data, local mobile data, remote server data, IoT data, and/or vehicle data. Stored information may be received via a network from a central server (e.g., central secure platform 280).

At step 606, the computing device determines, via an artificial intelligence (AI) model (e.g., a neural network/deep learning model) based on the user input and the stored information, one or more actions. For example, if the user requests a task to be performed such as purchasing train tickets, the one or more actions may be a sequence of actions including prompting the user for the desired destination, querying a GPS sensor for current location, accessing a ticketing service via a network, etc. The actions may be selected based on learned user preferences (e.g., preferred vendors etc.). If a learned preference is that the user prefers not to trust certain services with their identifying information, the computing device may use anonymized information. These preferences may be flexible since they are learned by an AI model. For example, even if a user tends to prefer to use an anonymized name, a train ticket may require the users actual name, and the computing device may determine that the users real name, which may be retrieved from memory, must be used in purchasing the ticket. In some embodiments, the one or more actions include accessing additional services of the computing device. Additional services may include sensor data access, involving obtaining or retrieving data from sensors on a local or remote computing device. Additional services may also include sensor data processing involving the analysis, and interpretation of data obtained from sensors, whether situated on a local or remote computing devices. Additional services may also include sensor data transmission involving the communication and transfer of data generated by sensors to other devices or systems. Additional services may also include selectively employing the services of a plurality of applications by interacting with services provided by a second local or remote application

At step 608, the computing device performs the one or more actions on the application. Performing the actions may include accessing memory, accessing network resources, accessing services provided by applications on the computing device, inputting security credentials into an application, etc.

At step 610, the computing device transmits output from the application to the user interface. For example, if the user requested weather information, the computing device may transmit the weather information to be displayed on the user interface.

At step 612, the computing device updates the stored information at the central server based on the user input. For example, if the user corrected information that was already stored at the central server, that information may be updated. The updated information at the central server may then be available to other devices without the need to update the information across multiple devices individually. In instances where there is no direct need to update specific information, the user input and actions performed may still be stored, or used to update the AI model such that future predictions may be informed by historical user behavior. In some embodiments, various sensor data may be sent to the central server associated with the historical data so that future predictions may be informed by the sensor data as well. For example, the central server and/or the AI wrapper of the computing device may learn a trend of certain user behavior associated with the user's location obtained via a GPS sensor.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method comprising:
receiving, by a computing device via a user interface, a user input associated with an application;
receiving, by the computing device via a data interface, stored information associated with a user;
determining, via an artificial intelligence (AI) model based on the user input and the stored information, one or more actions,
performing the one or more actions on the application; and
transmitting output from the application to the user interface.

2. The method of claim 1, wherein:
the stored information includes security credentials and learned user preferences associated with the security credentials;
the one or more actions include inputting the security credentials to the application.

3. The method of claim 2, wherein the determining includes determining, via the AI model, to input the security credentials in response to a determination that the application is trusted and authorized by the user based on the learned user preferences.

4. The method of claim 1, wherein the one or more actions includes providing anonymized data to the application.

5. The method of claim 1, wherein the one or more actions include accessing additional services of the computing device including at least one of:
sensor data access;
memory access; or
access services of a second application.

6. The method of claim 1, wherein the stored information comprises at least one of:
historical activities data, sensor data, local mobile data, remote server data, IoT data, or vehicle data.

7. The method of claim 1, wherein the receiving the stored information includes receiving, via a network, the stored information from a central server.

8. The method of claim 7, further comprising:
updating the stored information at the central server based on the user input.

9. The method of claim 1, wherein:
the application is a vehicle-based application,
the user interface is a vehicle-mounted user interface, and
the one or more actions include modifying a behavior of the application.

10. A computing device comprising:
one or more memories; and
one or more processors coupled to the one or more memories, the one or more memories storing instructions that are executable by the one or more processors, individually or in any combination, to cause the computing device to:
receive, via a user interface, a user input associated with an application;
receive, via a data interface, stored information associated with a user;
determine, via an artificial intelligence (AI) model based on the user input and the stored information, one or more actions,
perform the one or more actions on the application; and
transmit output from the application to the user interface.

11. The computing device of claim 10, wherein:
the stored information includes security credentials and learned user preferences associated with the security credentials;
the one or more actions include inputting the security credentials to the application.

12. The computing device of claim 11, wherein the one or more processors are further configured to cause the computing device to determine, via the AI model, to input the security credentials in response to a determination that the application is trusted and authorized by the user based on the learned user preferences.

13. The computing device of claim 10, wherein the one or more actions includes providing anonymized data to the application.

14. The computing device of claim 10, wherein the one or more actions include accessing additional services of the computing device including at least one of:
sensor data access;
memory access; or
access services of a second application.

15. The computing device of claim 10, wherein the stored information comprises at least one of:
historical activities data, sensor data, local mobile data, remote server data, IoT data, or vehicle data.

16. The computing device of claim 10, wherein the one or more processors are further configured to cause the computing device to receive the stored information includes receiving, via a network, the stored information from a central server.

17. The computing device of claim 16, wherein the one or more processors are further configured to cause the computing device to:
update the stored information at the central server based on the user input.

18. The computing device of claim 10, wherein:
the application is a vehicle-based application,
the user interface is a vehicle-mounted user interface, and
the one or more actions include modifying a behavior of the application.

19. A system comprising:
a plurality of edge devices configured to collect user data; and
a central secure platform communicatively connected via a communications channel to each edge device of the plurality of edge devices,
wherein the central secure platform is configured to:
store user data received from the plurality of edge devices, and
provide the stored user data to one or more service providers based on a policy defined by a user.

20. The system of claim 19, wherein the user data comprises at least one of: historical activities data, sensor data, local mobile data, remote server data, IoT data, or vehicle data.
